(19) United States
(12) Patent Application Publication
(10) Pub. No.: US 2021/0168556 A1
(43) Pub. Date: Jun. 3, 2021

(54) ELECTRONIC DEVICE AND METHOD FOR PROVIDING GEOFENCING SERVICE

(71) Applicant: Samsung Electronics Co., Ltd., Gyeonggi-do (KR)

(72) Inventors: Kumrye PARK, Gyeonggi-do (KR); Daeho KANG, Gyeonggi-do (KR); Yeunwoong KYUNG, Gyeonggi-do (KR); Seonik SEONG, Gyeonggi-do (KR); Sungrae CHO, Gyeonggi-do (KR); Kyoochun CHO, Gyeonggi-do (KR); Chaeman LIM, Gyeonggi-do (KR)

(21) Appl. No.: 17/099,863

(22) Filed: Nov. 17, 2020

(30) Foreign Application Priority Data
Nov. 29, 2019 (KR) 10-2019-0157748

(51) Int. Cl. H04W 4/021; G06Q 30/02

(52) U.S. Cl. CPC H04W 4/021; G06Q 30/0201; G06Q 30/0267; G06Q 30/0261

(57) ABSTRACT

An electronic device according to an embodiment of the disclosure may include a display, a communication module, a sensor module, and a first processor. The first processor is configured to: identify location information of the electronic device, identify whether the location information of the electronic device is within a first area, transmit a first message when the identified location information of the electronic device is within the first area, receive a first response message, display at least a part of information included in the first response message on the display, re-identify the location information of the electronic device, identify whether the re-identified location information of the electronic device is out of a second area, and delete the information displayed on the display when the re-identified location information of the electronic device is out of the second area. Other embodiments are also possible.

### CROSS-REFERENCE TO RELATED APPLICATION

This application is based on and claims priority under 35 U.S.C. § 119 to Korean Patent Application No. 10-2019-0157748 filed on Nov. 29, 2019, in the Korean Intellectual Property Office, the disclosure of which is herein incorporated by reference in its entirety.

### BACKGROUND

### Field

One or more embodiments of the instant disclosure generally relate to an electronic device and a method for providing a geofencing service.

### Description of Related Art

Proximity based marketing is a marketing strategy which can promote consumption by users of electronic devices and increase sales of an advertiser by transmitting, based on location to a specific electronic device, marketing information, such as advertisement, coupons, or events. The marketing information may be provided by the advertiser in a specific area (e.g., point of interest (POI)). For example, marketing information may be provided to the users of electronic devices geographically within the POI and are adjacent to the advertiser.

In the proximity based marketing, the process of determining proximity between an electronic device and the point of interest (POI) is called geofencing. Geofencing may determine proximity by checking the physical distance or the difference or similarity between location related information (e.g., latitude and longitude coordinates, cell ID, or Wi-Fi Access Point (AP) scan list) measured by the electronic device and location information (e.g., latitude and longitude coordinates, cell ID of a surrounding cell, or surrounding Wi-Fi AP scan list) representing the point of interest (POI).

Geofencing service may be a service for providing information to a plurality of electronic devices located in a predetermined area through the geofencing.

### SUMMARY

An electronic device may be provided with the geofencing service over a relatively long distance. Marketing information transmitted over long distances may not be relevant to the user and may be easily forgotten. Further, stale and unexpired marketing information may degrade the usefulness of the marketing information.

According to certain embodiments of the disclosure, the user can be provided with effective marketing information, and correspondingly the advertiser can obtain a sales increase.

An electronic device according to an embodiment of the disclosure may include: a display; a communication module; a sensor module; and a first processor, wherein the first processor is configured to: identify first location information of the electronic device, identify whether the identified first location information of the electronic device is within a first area, transmit a first message for requesting information related to a geofencing service in case that the identified first location information of the electronic device is within the first area, receive a first response message to the first message, display at least a part of information included in the first response message on the display, re-identify second location information of the electronic device, identify whether the re-identified second location information of the electronic device is out of a second area, and delete the information displayed on the display in case that the re-identified second location information of the electronic device is out of the second area.

A method for operating an electronic device providing a geofencing service according to an embodiment of the disclosure may include: identifying, by a first processor, first location information of the electronic device; identifying, by the first processor, whet her the identified first location information of the electronic device is within a first area; transmitting, by the first processor, a first message for requesting information related to a geofencing service in case that the identified first location information of the electronic device is within the first area; receiving, by the first processor, a first response message to the first message; displaying, by the first processor, at least a part of information included in the first response message on a display; re-identifying, by the first processor, second location information of the electronic device; identifying, by the first processor, whether the re-identified second location information of the electronic device is out of a second area; and deleting, by the first processor, the information displayed on the display in case that the re-identified second location information of the electronic device is out of the second area.

Effects that can be obtained in the disclosure are not limited to the above-described effects, and other unmentioned effects can be clearly understood by those of ordinary skill in the art to which the disclosure pertains from the following description.

### BRIEF DESCRIPTION OF THE DRAWINGS

In relation to the description of the drawings, the same or similar reference numerals may be used for the same or similar constituent elements. The above and other aspects, features and advantages of certain embodiments of the disclosure will be more apparent from the following detailed description, taken in conjunction with the accompanying drawings, in which:

FIG. 1 is a block diagram of an electronic device in a network environment according to an embodiment.

FIG. 2 is a block diagram exemplifying a program according to an embodiment.

FIG. 3 is a block diagram of an electronic device supporting a geofencing service based on a user status according to an embodiment of the disclosure.

FIG. 4 is a block diagram illustrating a system providing a geofencing service according to an embodiment of the disclosure.

FIG. 5 is a diagram illustrating a point of interest (POI) area for providing a geofencing service according to an embodiment of the disclosure.

FIG. 6 is a diagram illustrating a flowchart of an electronic device providing a geofencing service according to an embodiment of the disclosure.

FIG. 7 is a flowchart illustrating an electronic device providing a geofencing service according to another embodiment of the disclosure.

FIG. 8 is a diagram illustrating an example in which a user configures an opt in/out according to an embodiment of the disclosure.

FIG. 9 is a diagram illustrating an example in which a user configures an opt in/out according to an embodiment of the disclosure.

FIG. 10 is a diagram illustrating an example of first response message information displayed on an electronic device according to an embodiment of the disclosure.

FIG. 11 is a diagram illustrating an example of a screen for identifying additional information on first response message information according to an embodiment of the disclosure.

FIG. 12 is a diagram illustrating an example of identifying detailed information of second response message information displayed on an electronic device according to an embodiment of the disclosure.

FIG. 13 is a diagram illustrating an example of a screen for identifying additional information on second response message information according to an embodiment of the disclosure.

### DETAILED DESCRIPTION

According to the certain embodiments of the disclosure, the electronic device can provide a service for guiding the entrance into the point of interest (POI) using marketing information.

According to the certain embodiments of the disclosure, the electronic device can control to make the marketing information effective only in cases where the electronic device is in the location relevant for the marketing.

According to the certain embodiments of the disclosure, the server can adjust the service that can be provided to the user depending on whether the user is using the service.

Hereinafter, various embodiments of this document will be described with reference to the accompanying drawings.

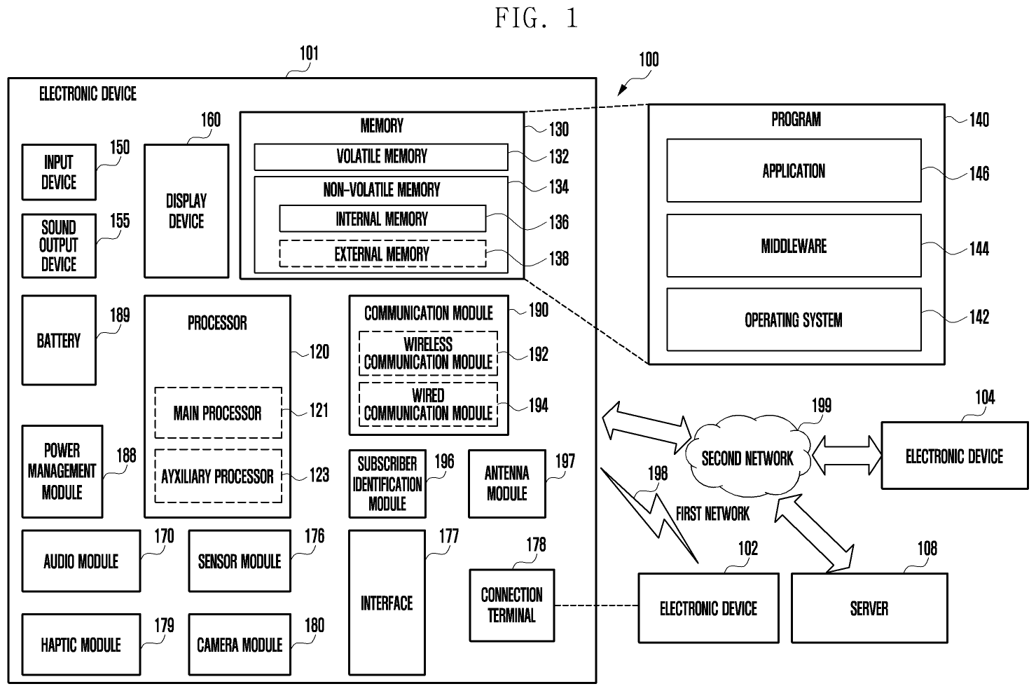

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input device 150, a sound output device 155, a display device 160, an audio module 170, a sensor module 176, an interface 177, a haptic module 179, a camera module 180, a power management module 188, a battery 189, a communication module 190, a subscriber identification module (SIM) 196, or an antenna module 197. In some embodiments, at least one (e.g., the display device 160 or the camera module 180) of the components may be omitted from the electronic device 101, or one or more other components may be added in the electronic device 101. In some embodiments, some of the components may be implemented as single integrated circuitry. For example, the sensor module 176 (e.g., a fingerprint sensor, an iris sensor, or an illuminance sensor) may be implemented as embedded in the display device 160 (e.g., a display).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may load a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display device 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input device 150 may receive a command or data to be used by other component (e.g., the processor 120) of the electronic device 101, from the outside (e.g., a user) of the electronic device 101. The input device 150 may include, for example, a microphone, a mouse, a keyboard, or a digital pen (e.g., a stylus pen).

The sound output device 155 may output sound signals to the outside of the electronic device 101. The sound output device 155 may include, for example, a speaker or a receiver. The speaker may be used for general purposes, such as playing multimedia or playing record, and the receiver may be used for an incoming calls. According to an embodiment, the receiver may be implemented as separate from, or as part of the speaker.

The display device 160 may visually provide information to the outside (e.g., a user) of the electronic device 101. The display device 160 may include, for example, a display, a hologram device, or a projector and control circuitry to control a corresponding one of the display, hologram device, and projector. According to an embodiment, the display device 160 may include touch circuitry adapted to detect a touch, or sensor circuitry (e.g., a pressure sensor) adapted to measure the intensity of force incurred by the touch.

The audio module 170 may convert a sound into an electrical signal and vice versa. According to an embodiment, the audio module 170 may obtain the sound via the input device 150, or output the sound via the sound output device 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., PCB). According to an embodiment, the antenna module 197 may include a plurality of antennas. In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 and 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, or client-server computing technology may be used, for example.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

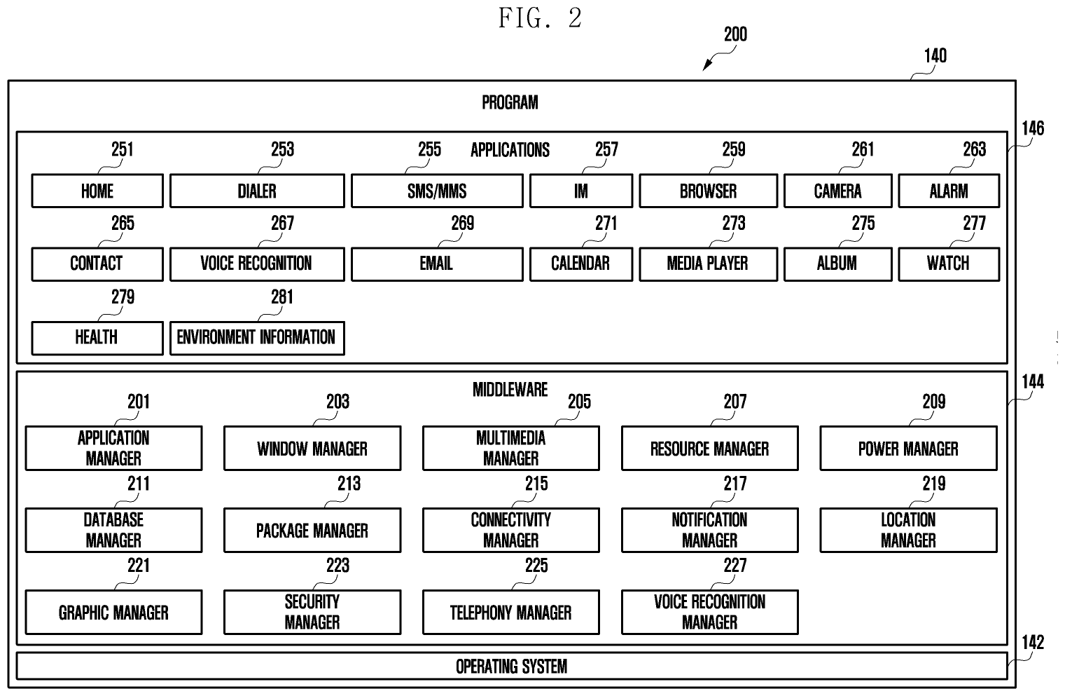

FIG. 2 is a block diagram 200 illustrating the program 140 according to various embodiments. According to an embodiment, the program 140 may include an operating system (OS) 142 to control one or more resources of the electronic device 101, middleware 144, or an application 146 executable in the OS 142. The OS 142 may include, for example, Android™, iOS™, Windows™, Symbian™, Tizen™, or Bada™. At least part of the program 140, for example, may be pre-loaded on the electronic device 101 during manufacture, or may be downloaded from or updated by an external electronic device (e.g., the electronic device 102 or 104, or the server 108) during use by a user.

The OS 142 may control management (e.g., allocating or deallocation) of one or more system resources (e.g., process, memory, or power source) of the electronic device 101. The OS 142, additionally or alternatively, may include one or more driver programs to drive other hardware devices of the electronic device 101, for example, the input device 150, the sound output device 155, the display device 160, the audio module 170, the sensor module 176, the interface 177, the haptic module 179, the camera module 180, the power management module 188, the battery 189, the communication module 190, the subscriber identification module 196, or the antenna module 197.

The middleware 144 may provide various functions to the application 146 such that a function or information provided from one or more resources of the electronic device 101 may be used by the application 146. The middleware 144 may include, for example, an application manager 201, a window manager 203, a multimedia manager 205, a resource manager 207, a power manager 209, a database manager 211, a package manager 213, a connectivity manager 215, a notification manager 217, a location manager 219, a graphic manager 221, a security manager 223, a telephony manager 225, or a voice recognition manager 227.

The application manager 201, for example, may manage the life cycle of the application 146. The window manager 203, for example, may manage one or more graphical user interface (GUI) resources that are used on a screen. The multimedia manager 205, for example, may identify one or more formats to be used to play media files, and may encode or decode a corresponding one of the media files using a codec appropriate for a corresponding format selected from the one or more formats. The resource manager 207, for example, may manage the source code of the application 146 or a memory space of the memory 130. The power manager 209, for example, may manage the capacity, temperature, or power of the battery 189, and determine or provide related information to be used for the operation of the electronic device 101 based at least in part on corresponding information of the capacity, temperature, or power of the battery 189. According to an embodiment, the power manager 209 may interwork with a basic input/output system (BIOS) (not shown) of the electronic device 101.

The database manager 211, for example, may generate, search, or change a database to be used by the application 146. The package manager 213, for example, may manage installation or update of an application that is distributed in the form of a package file. The connectivity manager 215, for example, may manage a wireless connection or a direct connection between the electronic device 101 and the external electronic device. The notification manager 217, for example, may provide a function to notify a user of an occurrence of a specified event (e.g., an incoming call, message, or alert). The location manager 219, for example, may manage locational information on the electronic device 101. The graphic manager 221, for example, may manage one or more graphic effects to be offered to a user or a user interface related to the one or more graphic effects.

The security manager 223, for example, may provide system security or user authentication. The telephony manager 225, for example, may manage a voice call function or a video call function provided by the electronic device 101. The voice recognition manager 227, for example, may transmit a user's voice data to the server 108, and receive, from the server 108, a command corresponding to a function to be executed on the electronic device 101 based at least in part on the voice data, or text data converted based at least in part on the voice data. According to an embodiment, the middleware 244 may dynamically delete some existing components or add new components. According to an embodiment, at least part of the middleware 144 may be included as part of the OS 142 or may be implemented as another software separate from the OS 142.

The application 146 may include, for example, a home 251, dialer 253, short message service (SMS)/multimedia messaging service (MMS) 255, instant message (IM) 257, browser 259, camera 261, alarm 263, contact 265, voice recognition 267, email 269, calendar 271, media player 273, album 275, watch 277, health 279 (e.g., for measuring the degree of workout or biometric information, such as blood sugar), or environmental information 281 (e.g., for measuring air pressure, humidity, or temperature information) application. According to an embodiment, the application 146 may further include an information exchanging application (not shown) that is capable of supporting information exchange between the electronic device 101 and the external electronic device. The information exchange application, for example, may include a notification relay application adapted to transfer designated information (e.g., a call, message, or alert) to the external electronic device or a device management application adapted to manage the external electronic device. The notification relay application may transfer notification information corresponding to an occurrence of a specified event (e.g., receipt of an email) at another application (e.g., the email application 269) of the electronic device 101 to the external electronic device. Additionally or alternatively, the notification relay application may receive notification information from the external electronic device and provide the notification information to a user of the electronic device 101.

The device management application may control the power (e.g., turn-on or turn-off) or the function (e.g., adjustment of brightness, resolution, or focus) of the external electronic device or some component thereof (e.g., a display device or a camera module of the external electronic device). The device management application, additionally or alternatively, may support installation, delete, or update of an application running on the external electronic device.

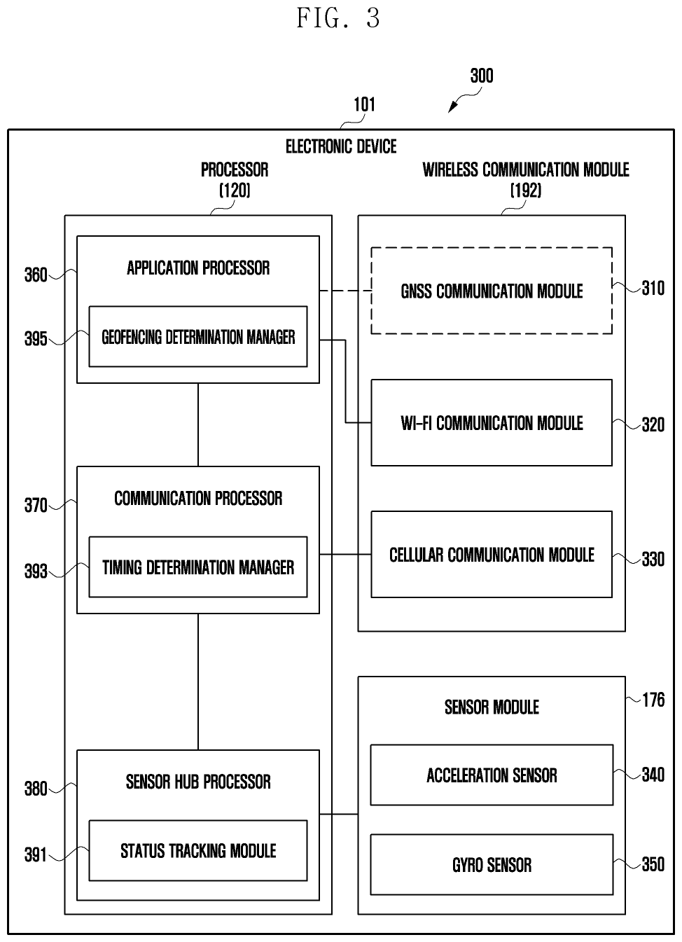

FIG. 3 is a block diagram 300 of an electronic device 101 supporting a geofencing service based on a user status according to an embodiment of the disclosure.

With reference to FIG. 3, a wireless communication module 192 may include a GNSS communication module 310, a wireless fidelity (Wi-Fi) communication module 320, and a cellular communication module 330. The sensor module 176 may include an acceleration sensor 340 and a gyro sensor 350. The processor 120 may include an application processor 360, a communication processor 370, and a sensor hub processor 380. The GNSS may be, for example, the global positioning system (GPS), the global navigation satellite system (Glonass), the Beidou navigation satellite system (hereinafter, “Beidou”), or Galileo, the European global satellite-based navigation system. Hereinafter, in this document, “GPS” may be interchangeably used with the “GNSS”. The GNSS communication module 310 may be omitted from the wireless communication module 192. The processor 120 may include a microprocessor or any suitable type of processing circuitry, such as one or more general-purpose processors (e.g., ARM-based processors), a Digital Signal Processor (DSP), a Programmable Logic Device (PLD), an Application-Specific Integrated Circuit (ASIC), a Field-Programmable Gate Array (FPGA), a Graphical Processing Unit (GPU), a video card controller, etc. In addition, it would be recognized that when a general purpose computer accesses code for implementing the processing shown herein, the execution of the code transforms the general purpose computer into a special purpose computer for executing the processing shown herein. Certain of the functions and steps provided in the Figures may be implemented in hardware, software or a combination of both and may be performed in whole or in part within the programmed instructions of a computer. No claim element herein is to be construed under the provisions of 35 U.S.C. § 112(f), unless the element is expressly recited using the phrase “means for.” In addition, an artisan understands and appreciates that a “processor” or “microprocessor” may be hardware in the claimed disclosure. Under the broadest reasonable interpretation, the appended claims are statutory subject matter in compliance with 35 U.S.C. § 101.

According to an embodiment of the disclosure, the sensor hub processor 380 (e.g., auxiliary processor 123 of FIG. 1) may include a status tracking module 391, and may be operatively connected to the sensor module 176. The status tracking module 391 may be hardware in the sensor hub processor 380, and may be configured to perform a given function (e.g., the operation of recognizing a user status (e.g., stationary status, walking status, running status, on a bicycle, or in a car) and/or the operation of recognizing a status change using data received from the sensor module 176). The status tracking module 391 may be implemented by software (e.g., program 140 of FIG. 1), and when the status tracking module 391 is executed, the sensor hub processor 380 may perform instructions of the status tracking module 391. The sensor hub processor 380 may activate or deactivate the function of the status tracking module 391 based on control of the communication processor 370.

According to an embodiment of the disclosure, the communication processor 370 (e.g., auxiliary processor 123 of FIG. 1) may include a timing determination manager 393, and may be operatively connected to the application processor 360, the sensor hub processor 380, and the cellular communication module 330. The timing determination manager 393 may be hardware provided in the communication processor 370, and may be configured to perform given functions (e.g., the operation of determining the timing to perform positioning based on the recognized user status and/or the change of the status and the operation of transmitting a timing notification for requesting the positioning in the determined positioning timing). The timing determination manager 393 may be implemented by software (e.g., program 140), and when the timing determination manager 393 is executed, the communication processor 370 may perform instructions of the timing determination manager 393. The communication processor 370 may activate or deactivate the function of the timing determination manager based on control of the application processor 360.

According to an embodiment of the disclosure, the communication processor 370 may estimate the latitude and the longitude using cellular information (e.g., base station information) received from the cellular communication module 330. The communication processor 370 may transmit information indicating the estimated latitude and longitude together when transmitting the timing notification to the application processor 360.

According to an embodiment of the disclosure, the application processor 360 (e.g., main processor 121 of FIG. 1) may execute the geofencing service based on a user input. For example, the application processor 360 may download an application supporting the geofencing service from a server of an application store (e.g., Play Store™) based on the user input to install the downloaded application in the electronic device 101, and may execute the geofencing service. The application processor 360 may determine activation of the geofencing service based on the user input. For example, based on the user input received from an input device (e.g., input device 150 or touch screen display of a display device 160), the application processor 360 may display settings including an item (e.g., message to ask for agreement to receive advertisement) for enabling the user to select whether to activate the geofencing service, and may determine the activation of the geofencing service based on the user's selection of the item in the settings.

According to an embodiment of the disclosure, the application processor 360 may receive geofence information from a server (e.g., server 108 of FIG. 1) using the wireless communication module 192, and may store the received geofence information in a memory (e.g., memory 130 of FIG. 1). The geofence information may include, for example, latitude and longitude information, identification information of an access point (AP) (e.g., basic service set identifier (BSSID)) located in the geofence, a communication channel, a received signal strength indicator (RSSI), or a service profile (e.g., radius around the geofence, required latency, or event type (e.g., entry and/or exit)).

According to an embodiment of the disclosure, the application processor 360 may transmit a message for requesting the information from the server using the wireless communication module 192, based on occurrence of an event designated by the electronic device 101, and may store the geofence information received from the server in the memory 130 in response to the request. For example, the application processor 360 may add the received information to the geofence list as new geofence information, or may update existing information using the received information.

According to an embodiment of the disclosure, the application processor 360 may include a geofencing determination manager 395, and may be operatively connected to the GNSS communication module 310, the Wi-Fi communication module 320, and the communication processor 370. The geofencing determination manager 395 may be hardware provided in the application processor 360, and may be configured to perform given operations (e.g., operations of determining start and end of tracking the user status, determining the positioning timing, and/or determining suspense and resume of the timing notification). The geofencing manager 395 may be implemented by software (e.g., program 140), and when the geofencing manager 395 is executed, the application processor 360 may perform instructions of the geofencing determination manager 395.

According to an embodiment of the disclosure, the application processor 360 may perform positioning during the determined positioning timing. For example, the application processor 360 may measure the location of the electronic device 101 using a positioning source in response to the timing notification received from the communication processor 370. The application processor 360 may use the Wi-Fi communication module 320 as the positioning source. The application processor 360 may also use the GNSS communication module 310 as the positioning source, instead of the Wi-Fi communication module 320.

According to an embodiment of the disclosure, the application processor 360 may recognize that the user has entered into or exited out of the geofence based on the location information obtained from the positioning. For example, the application processor 360 may determine whether a point of interest (POI) (e.g., geofence) exists in the neighborhood of the electronic device (e.g., within a designated radius from the current location) based on the location information obtained using the GNSS communication module 310. If it is determined that the POI exists in the neighborhood, the processor 360 may proceed to recognize whether the user enters into or exits out of the geofence based on the location information obtained using the Wi-Fi communication module 320.

According to an embodiment of the disclosure, the application processor 360 may provide information related to the corresponding geofence (e.g., advertisement) through the display device (e.g., display device 160 of FIG. 1) and/or a sound output device (e.g., sound output device 155 of FIG. 1) based on the recognition.

According to an embodiment of the disclosure, the application processor 360 may receive, from the communication processor 370, the latitude and longitude information estimated by the communication processor 370 together with the timing notification. The application processor 360 may determine whether to measure the location of the electronic device 101 by actually using the positioning source (e.g., GNSS communication module 310 and/or Wi-Fi communication module 320) based on the reception of the timing notification using the latitude and longitude information received from the communication processor 370. For example, if the geofence exists around the latitude and the longitude estimated by the communication processor 370, the application processor 360 may perform the location measurement using the positioning source in response to the reception of the timing notification. In case that the geofence does not exist around the estimated latitude and longitude although the timing notification is received, the application processor 360 may not perform the location measurement using the positioning source.

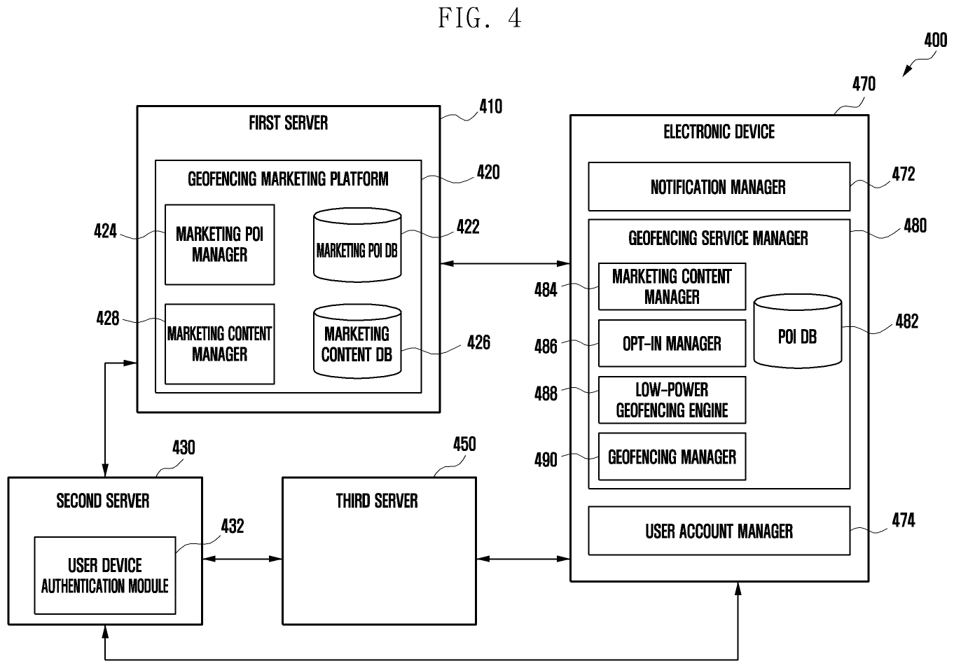

FIG. 4 is a block diagram illustrating a system providing a geofencing service according to an embodiment of the disclosure.

With reference to FIG. 4, a system 400 providing a geofencing service according to an embodiment of the disclosure may include at least one of a first server 410 (e.g., server 108 of FIG. 1) (e.g., marketing server), a second server 430 (e.g., server 108 of FIG. 1) (e.g., user authentication server), a third server 450 (e.g., server 108 of FIG. 1) (e.g., geofencing service providing server), and an electronic device 470 (e.g., electronic device 101 of FIG. 1).

According to an embodiment of the disclosure, the first server 410 may include a geofencing marketing platform 420, and the marketing platform 420 may include a point of interest (POI) database 422, a POI manager 424, a marketing content database 426, and a marketing content manager 428.

According to an embodiment of the disclosure, the first server 410 may store information on the point of interest (POI). The first server 410 may store the information on the POI in the POI database 422. The information on the POI may include at least parts of identification information of the POI (e.g., POI ID), geofencing configuration information (e.g., exposure time, frequency of exposure, and number of coupon issues), geofencing activation condition (e.g., geofencing entry/exit), and identification information of marketing content (e.g., marketing content ID). The first server 410 may manage the information on the POI stored in the POI database 422 including the marketing content identification information, marketing content expiration dates, exposure time information of the day, and the frequency of marketing exposure using the POI manager 424. A plurality of marketing content may be registered in one POI. Further, there may be a POI in which the marketing content is not registered.

According to an embodiment of the disclosure, the first server 410 may store the information on the marketing content. For example, the first server 410 may include a marketing portal (e.g., web page) for registering the marketing content, and a service provider may store, in the marketing content database 426, the information related to the marketing content including text and/or images to be seen through a notification that is transmitted to a user terminal through the marketing portal, a landing page uniform resource locator (URL) of a marketing promotion to be entered through identifying of the notification, and a coupon that is provided in case a promotion condition is satisfied. The first server 410 may manage the information related to the marketing content stored in the marketing content database 426 using the marketing content manager 428.

According to an embodiment of the disclosure, the first server 410, although not illustrated, may include a processor and a memory. The marketing POI manager 424 and the marketing content manager 428 may be stored in the memory as instructions, and may be executed by the processor. The POI database 422 and the marketing content database 426 may be stored in the memory.

According to an embodiment, the first server 410 may receive a message for requesting a POI list from the electronic device 470. For example, the first server 410 may transmit the message including the POI list only to the electronic device 470 when the electronic device 470 is authenticated. The message for requesting the POI list may include location information of the electronic device 470 (e.g., latitude, longitude, and/or identification information indicating a predetermined area). The first server 410 may transmit the POI list corresponding to the location information of the electronic device 470.

According to an embodiment of the disclosure, the first server 410 may receive the message for requesting the information on the POI from the electronic device 470. The electronic device 470 may transmit the message for requesting the information on the POI based on the identified location of the electronic device 470 and the received POI list. The first server 410 may transmit the information on the POI requested by the electronic device 470.

According to an embodiment of the disclosure, the second server 430 may include a user device authentication manager 432 for authenticating the user device (e.g., electronic device). The user device authentication manager 432 of the second server 430 may authenticate the user device after being requested by at least one of the electronic device 470, the first server 410, and the third server 450. For example, if the second server 430 is a server being operated by the manufacturer of the electronic device 470, the second server 430 may authenticate the electronic device 470 using a program (e.g., background program or operating program) installed by the manufacturer. As another example, the second server 430 may be a server being operated by the company that provides a particular authentication service, and may authenticate the user device having agreed to provide the authentication service using an application for performing the authentication service.

According to an embodiment of the disclosure, if the electronic device 470 request the authentication of the electronic device 470 by transmitting the information of the electronic device 470, the second server 430 may transmit an access token to the authenticated electronic device 470 only.

According to an embodiment of the disclosure, the second server 430, although not illustrated, may include a processor and a memory. The user device authentication manager 432 may be stored in the memory as instructions, and may be executed by the processor.

According to an embodiment of the disclosure, the third server 450 may be a server being operated by an operator that provides the geofencing service. The third server 450 may receive identification information (e.g., ID or identification number) of the electronic device 470 and the access token from the electronic device 470, and may perform the authentication of the electronic device 470. For example, if the third server 450 transmits the received identification information of the electronic device 470 and access token to the second server 430, the second server 430 may transmit the result of the authentication of the electronic device 470 to the third server 450. The third server 450 may identify an opt-in condition (e.g., whether to agree with the service in the electronic device, whether to receive user's marketing information, and reception condition) only with respect to the authenticated electronic device 470, and may transmit service status information to the electronic device 470.

Although as illustrated, the functionalities of the system are divided between different servers, alternatively, the functionalities may be implemented in a single server.

According to an embodiment of the disclosure, the electronic device 470 may be a device being provided with the geofencing service. The electronic device 470 (e.g., processor 121 or application processor 360) may include at least one of a notification manager 472, a user account manager 474, and a geofencing service manager 480.

According to an embodiment of the disclosure, the notification manager 472 may perform the function of displaying a message to the user in various applications or services through a notification interface (e.g., notification bar or pop-up) of the electronic device 470. The notification manager 472 may display the message in various types in accordance with the configurations of the various applications or services.

According to an embodiment of the disclosure, the user account manager 474 may manage information for user authentication. The user account manager 474 may manage user's identification information and access token as the information for the user authentication. The access token may be updated as needed or may be periodically updated. The user's identification information and/or the access token may be stored in a memory (not illustrated) (e.g., memory 130 of FIG. 1) of the electronic device 470. As an example, the user's identification information and/or the access token may be stored in a security area of the memory (e.g., logically or physically separated area of the memory).

According to an embodiment of the disclosure, the geofencing service manager 480 may include a marketing content manager 484, an opt-in manager 486, a low-power geofencing engine 488, a geofencing manager 490, and a POI database 482.

According to an embodiment of the disclosure, the geofencing manager 490 may request and receive, from the first server 410, information on the point of interest (POI) around a constant radius based on the current location. The geofencing manager 490 may store the received information on the POI in the POI database 482. The geofencing manager 490 may include a low-power geofencing engine function, or may be registered in the low-power geofencing engine 488 as a client.

According to an embodiment of the disclosure, the low-power geofencing engine 488 may provide the geofencing service with low power. As a system service, the low-power geofencing engine 488 may provide the low-power geofencing service to applications registered as clients. The low-power geofencing service may include the operation of estimating, by the communication processor (e.g., communication processor 370 of FIG. 3), the latitude and the longitude using information (e.g., base station information) of a cellular base station.

According to an embodiment of the disclosure, in the POI database 482, the information on the point of interest (POI) that is received from the first server 410 may be stored. In the POI database 482, information, such as the identification information of the point of interest (POI) (e.g., POI ID), the geofencing configuration information (e.g., exposure time, the frequency of exposure, and the number of coupon issues), the geofencing activation condition (e.g., geofencing entry/exit), and the identification information of the marketing content (e.g., marketing content ID), may be stored.

According to an embodiment of the disclosure, if the geofencing event (geofence entry/exit) is received from the geofencing manager 490, the marketing content manager 484 may request the marketing content for the corresponding point of interest from the first server 410, and may manage the received marketing content.

According to an embodiment of the disclosure, the opt-in manager 486 may identify the service status information in accordance with the opt-in condition identified through the third server 450, and if agreeing with the opt-in condition, the opt-in manager 486 may request the registered point of interest (POI) list based on the location of the electronic device 470 identified through an access to the first server 410, and may store the requested POI list. The opt-in manager 486 may request the registered point of interest (POI) list based on the location of the electronic device 470 periodically or as needed, and may update the received point of interest (POI) list. The geofencing manager 490 may perform monitoring of whether the electronic device 470 enters into or exits out of the point of interest (POI) area (e.g., first area or second area described below).

According to an embodiment of the disclosure, if the electronic device 470 enters into or exits out of the point of interest (POI) area, the geofencing service manager 480 may request information related to the marketing content from the first server 410 by transmitting a message including the identification information of the point of interest (POI) and information on entering into or exiting out of the point of interest (POI) area to the first server 410. The geofencing service manager 480 may display the information related to the marketing content received from the first server 410. If the electronic device 470 exits out of the point of interest area, the geofencing service manager 480 may delete the displayed information related to the marketing content.

According to an embodiment of the disclosure, one point of interest (POI) area may be divided into a plurality of areas (e.g. concentric circles around the center of the POI). Different geofencing services may be provided for the plurality of areas. The geofencing manager 490 may receive and display the information related to the marketing content by transmitting information on the divided areas or the location of the electronic device 470 to the first server 410. For example, if identification information of the divided areas exists, the electronic device 470 may transmit the identification information of the areas, whereas if the identification information of the divided areas does not exist, the electronic device 470 may transmit the identification information of the point of interest (POI) and the location information of the electronic device 470.

According to an embodiment, the geofencing service manager 480 (e.g., low-power geofencing engine 488) may measure/calculate the location information (e.g., latitude and longitude) of the electronic device in the time determined by the timing determination manager 393 and/or the geofencing determination manager 395 of FIG. 3. For example, the geofencing service manager 480 may measure/calculate the location information of the electronic device based on the information obtained using the cellular communication module 330 and/or the Wi-Fi communication module 320.

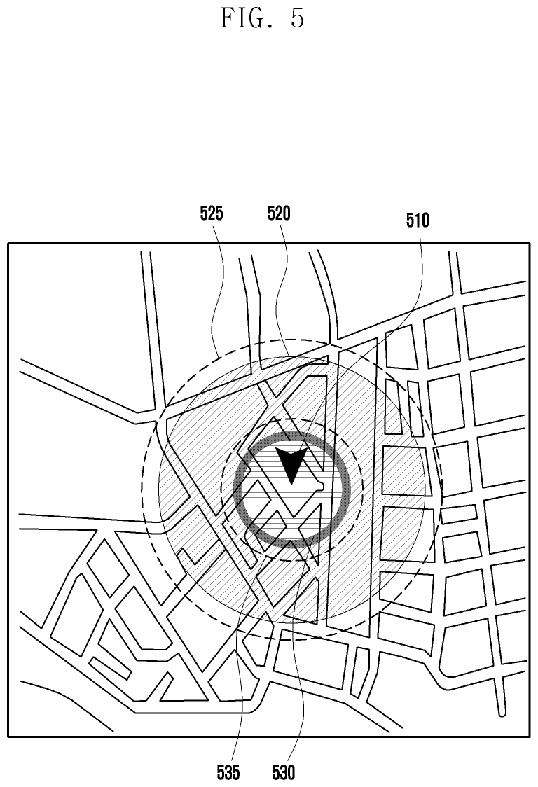

FIG. 5 is a diagram illustrating a point of interest (POI) area for providing a geofencing service according to an embodiment of the disclosure.

According to an embodiment of the disclosure, a user who possesses an electronic device (e.g., electronic device 470 of FIG. 4) may be on the move. The electronic device 470 may determine the user status of the electronic device 470 using a sensor module (e.g., sensor module 176 of FIG. 3). The user status may be, for example, stationary status, walking status, running status, on a bicycle, or in a car. The electronic device 470 may determine the user status using a second processor (e.g., communication processor 370 of FIG. 3), and may identify the location information of the electronic device 470 using a first processor (e.g., application processor 360 of FIG. 3). The electronic device 470 may be provided with geofencing service based on the movement status.

According to an embodiment of the disclosure, an area in which the electronic device 470 can be provided with the geofencing service may be divided into, for example, a first area 520, a first surrounding area 525, a second area 530, and a second surrounding area 535 having different radii from the center of the point of interest (POI) 510. The first area 520 may be an area having a large radius centering around the point of interest (POI) 510, and the first surrounding area 525 may be a surrounding area of the first area 520. The first surrounding area 525 may be an area corresponding to when the electronic device 470 deletes a received message when the electronic device 470 exits out of the first area 520. The second area 530 may be an area having a small radius centering around the point of interest (POI) 510, and the second surrounding area 535 may be a surrounding area of the second area 530. In the same manner as the first surrounding area 525, the second surrounding area 535 may also be an area corresponding to when the electronic device 470 deletes the received message when the electronic device 470 exits out of the second area 530. Information on the first area 520, the first surrounding area 525, the second area 530, and the second surrounding area 535 (e.g., identification information of the point of interest (POI), location information (latitude and longitude) of the point of interest (POI), and radii centering around the point of interest (POI)) may be received from a marketing server (e.g., first server 410 of FIG. 4).

According to an embodiment of the disclosure, the first area 520 may be a relatively large area in which there is a possibility that the electronic device 470 visits the point of interest (POI) 510. The first area 520 may be an area in which a server (e.g., first server 410 of FIG. 4) starts marketing. The first area 520 may be configured as a location in which the electronic device 470 has not yet arrived in the vicinity of the point of interest (POI) 510, but will be able to arrive within a predetermined time if the electronic device is assumed to move at a certain speed. Because it is unclear whether the electronic device 470 is going to visit the point of interest (POI), information for attracting the user may be provided to the electronic device 470.

According to an embodiment of the disclosure, the second area 530 may be an area indicating that the electronic device 470 is in the neighborhood of the point of interest (POI) 510. The second area 530 may be an area in which the server 410 transmits additional information to the electronic device 470. The server 410 may provide marketing content, such as coupon, to the electronic device 470. Further, the second area 30 may be an area indicating that the electronic device 470 has entered into the point of interest (POI) 510. The server 410 may provide the marketing content to the electronic device 470. When entering into the first area 520 or the second area 530, the electronic device 470 may transmit, to the server 410, a message for requesting the marketing content in accordance with the entering into the first area 520 or the second area 530. The first message or a second message may include at least one of information on the location of the electronic device 470 and information for requesting the marketing content. In this case, the message being transmitted by the electronic device 470 may be indicated as the first message or the second message, and the server 410 may transmit a first response message or a second response message to the electronic device 470 in response to the first message or the second message. The first response message or the second response message may include at least one of information on the marketing content, screen configuration information (e.g., xml) to configure the display of the marketing content, and URL information. The first response message or the second response message may be provided in the form of a push. The server 410 may transmit the second response message to the electronic device 470 only after it has identified the first response message by entering into the first area 520. For example, if the first response message received by the electronic device 470 having entered into the first area 520 include discount information of a specific product, the second response message may include a discount coupon. The server 410 may be configured to transmit the second response message depending on whether the electronic device 470 has identified the first response message after entered into the first area 520.

According to an embodiment of the disclosure, the first response message received by the electronic device 470 having entered into the first area 520 and the second response message received by the electronic device 470 having entered into the second area 530 may include different kinds of information. The first and/or second response message may include at least one of information related to simple marketing content, a discount coupon, and a gift coupon. The deletion of the first and/or second response message may require user's authorization.

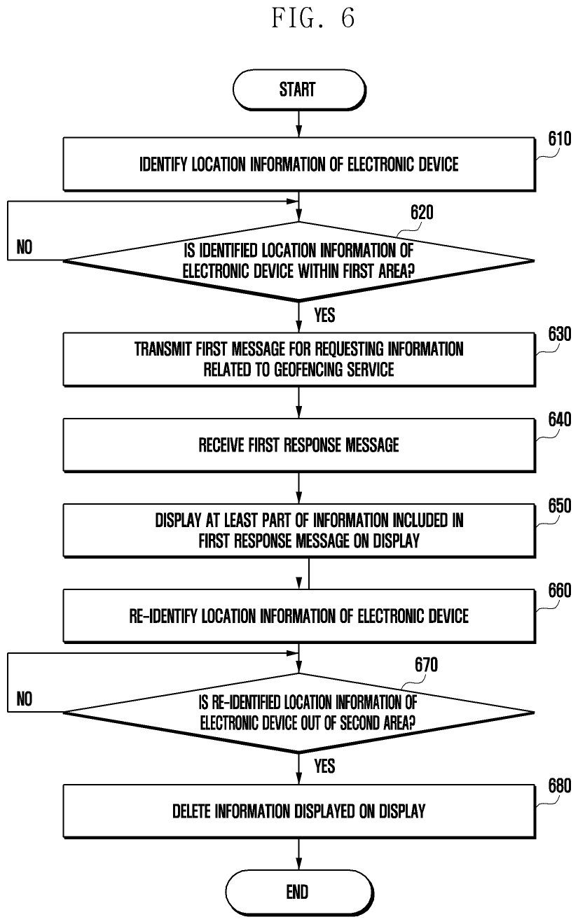

FIG. 6 is a diagram illustrating a flowchart of an electronic device providing a geofencing service according to an embodiment of the disclosure.

According to an embodiment of the disclosure, operations 610 to 680 may be performed by a first processor (e.g., processor 120 of FIG. 1 or application processor 360 of FIG. 3) of an electronic device (e.g., electronic device 101 of FIG. 1 or electronic device 470 of FIG. 4).

According to an embodiment of the disclosure, the electronic device 470 may identify location information of the electronic device 470 (610). The electronic device 470 may further include a second processor (e.g., communication processor 370 of FIG. 3), and may identify location information of the electronic device 470 using the first processor 360 when a request to identify the location information is transferred by the second processor 370. The second processor 370 may determine the timing when the first processor 360 identifies the location information of the electronic device 470 by first estimating the location information of the electronic device 470 based on at least one base station signal strength being currently measured. The electronic device 470 may determine the timing when the first processor 360 identifies the location information of the electronic device 470 by further identifying movement pattern information of the electronic device (e.g., stationary status, walking status, running status, on a bicycle, or in a car) obtained using a sensor module (e.g., acceleration sensor or gyro sensor). The second processor 370 of the electronic device 470 may request the first processor 360 to identify the location information in the determined identification timing. The electronic device 470 may determine the location information of the electronic device 470 based on at least one Wi-Fi access point (AP) signal strength being currently measured. The electronic device 470 may determine the location information of the electronic device 470 by comparing the at least one Wi-Fi AP list being currently measured with the Wi-Fi AP list that may be measured in accordance with the location.

According to an embodiment of the disclosure, if there is not a list of the point of interest in the identified location information, the electronic device 470 may request the list of the point of interest from the marketing server 410.

According to an embodiment of the disclosure, the electronic device 470 may identify whether the identified location information of the electronic device 470 is within the first area (e.g., first area 520 of FIG. 5) (620).

According to an embodiment of the disclosure, if the identified location information of the electronic device 470 is within the first area 520 (620—Yes), the electronic device 470 may transmit a first message for requesting information related to a geofencing service (630). The first message may further include identification information of the point of interest (POI) based on the identified location information of the electronic device 470. The electronic device 470 may transmit the first message to the marketing server (e.g., first server 410 of FIG. 4).

According to an embodiment of the disclosure, the electronic device 470 may receive a first response message to the first message (640). The first response message may be provided in the form of a push.

According to an embodiment of the disclosure, the electronic device 470 may display, on a display, at least parts of the information included in the received first response message (e.g., information related the marketing content, coupon, gift, and corresponding time) (650). The at least parts of the information included in the received first response message may be displayed in the form of being in a notification interface (e.g., notification bar or notification message), and may be configured to be unable to be deleted by the user.

According to an embodiment of the disclosure, the electronic device 470 may re-identify the location information of the electronic device 470 (660). The electronic device 470 may re-identify the location information of the electronic device 470 using the first processor 360 (660).

According to an embodiment of the disclosure, the electronic device 470 may identify whether the identified location information of the electronic device 470 is out of a second area (e.g., first area 520 or the first surrounding area 525 of FIG. 5) (670). The second area may be the first surrounding area 525 that is equal to or larger than the first area.

According to an embodiment of the disclosure, if the identified location information of the electronic device 470 is out of the second area 525 (670—Yes), the electronic device 470 may delete the information displayed on the display (680). The electronic device 470 may delete the information displayed on the display by further identifying whether a predetermined condition is satisfied by at least one or a combination of expiration of a predetermined time interval (e.g., marketing exposure time interval or exit time interval out of the second area) and the number of exits out of the second area. For example, the electronic device 470 may temporarily exit out of the second area, and thus may delete the information displayed on the display after the predetermined time interval has elapsed even if the electronic device 470 exits out of the second area. This way, the electronic device 470 may delete the information from the display using a combination of whether the device exits the second area and the predetermined time interval.

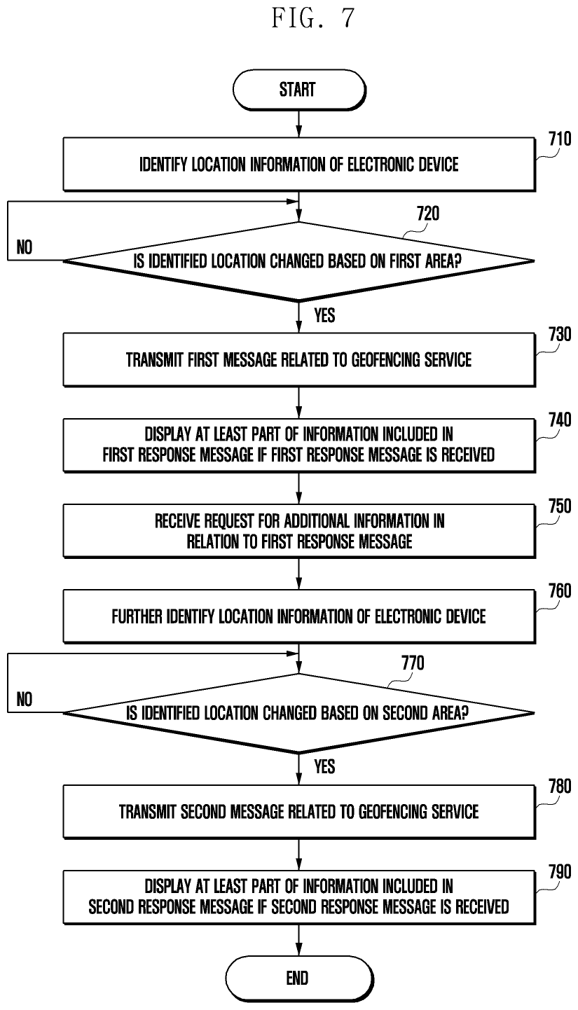

FIG. 7 is a flowchart illustrating an electronic device providing a geofencing service according to another embodiment of the disclosure.

According to an embodiment of the disclosure, operations 710 to 790 may be performed by a first processor (e.g., processor 120 of FIG. 1) of an electronic device (e.g., electronic device 101 of FIG. 1 or electronic device 470 of FIG. 4).

According to an embodiment of the disclosure, the electronic device 470 may be an electronic device having completed user authentication and having agreed with the opt-in condition.

According to an embodiment of the disclosure, the electronic device 470 may request and receive a point of interest (POI) list periodically or as needed. The electronic device 470 may transmit a message for requesting the point of interest (POI) list to an external electronic device (e.g., first server 410 of FIG. 3) based on the identified location information of the electronic device 470.

According to an embodiment of the disclosure, the electronic device 470 may identify the location information of the electronic device 470 (710). The electronic device 470 may identify the location information of the electronic device 470 in order to determine whether the location of the electronic device 470 is included in the point of interest (POI) list. The electronic device 470 may further include a second processor (e.g., communication processor 370 of FIG. 3), and may identify the location information of the electronic device 470 using the first processor 360 when a request to identify the location information is transferred by the second processor 370. The second processor 370 may determine the timing when the first processor 360 identifies the location information of the electronic device 470 by first estimating the location information of the electronic device 470 based on at least one base station signal strength being currently measured. The electronic device 470 may determine the timing when the first processor 360 identifies the location information of the electronic device 470 by further identifying movement pattern information of the electronic device (e.g., stationary status, walking status, running status, on a bicycle, or in a car) obtained using a sensor module (e.g., acceleration sensor or gyro sensor). The electronic device 470 may determine the location information of the electronic device 470 based on at least one Wi-Fi access point (AP) signal strength being currently measured. The electronic device 470 may determine the location information of the electronic device 470 by comparing the at least one Wi-Fi AP list being currently measured with the Wi-Fi AP list that may be measured in accordance with the location.

According to an embodiment of the disclosure, the electronic device 470 may identify the location information of the electronic device 470 using the processor (e.g., processor 120 of FIG. 1 or application processor 360 of FIG. 3). The electronic device 470 may calculate the movement speed of the electronic device 470 using at least one of a sensor module (e.g., sensor module 176 of FIG. 1) and a communication module (e.g., communication module 190 of FIG. 1). For example, the electronic device 470 may identify the location information (e.g., latitude and longitude) of the electronic device 470 using a cell ID of a surrounding base station and a surrounding Wi-Fi list. As another example, the electronic device 470 may identify the location information of the electronic device 470 using surrounding geographic information measured using the sensor module 176 (e.g., image sensor).

According to an embodiment of the disclosure, the electronic device 470 may identify whether the identified location of the electronic device 470 is changed based on the first area (e.g., first area 520 of FIG. 5) (720). For example, the electronic device 470 may determine whether the electronic device 470 enters into or exits out of the first area 520. The first area 520 may be an area having a large radius centering around the point of interest (POI) (e.g., the point of interest (POI) 510 of FIG. 5).

According to an embodiment of the disclosure, if it is identified that the location of the electronic device 470 is changed based on the first area 520 (720—Yes), the electronic device 470 may transmit a first message related to the geofencing service (730). If it is identified that the electronic device 470 enters into the first area 520, the first message may correspond to a case where the location information of the electronic device 470 enters into the first area 520, and may be a message for requesting information on the point of interest (POI). As another example, if it is identified that the electronic device 470 exits out of the first area 520, the first message may be a message for notifying the exit of the electronic device 370. The electronic device 470 may transmit the first message to the external electronic device (e.g., first server 410 of FIG. 4). The electronic device 470 may further include the identification information of the point of interest based on the location information of the electronic device 470 and information on whether the electronic device 470 enters into or exits out of the first area in the first message to be transmitted.

According to an embodiment of the disclosure, if a first response message to the first message is received, the electronic device 470 may display information related to the first response message (hereinafter, “first response message information”) on a display (740). For example, the first response message may include a uniform resource locator (url) and/or user interface information (e.g., information capable of configuring a web UI, such as html, xml, and text). For example, the electronic device 470 may display the user interface information included in the first response message on the display (e.g., using a web browser). In another example, the electronic device 470 may receive the information capable of configuring a screen by accessing the url included in the first response message, and may display the received information on the display (e.g., using web browser). Further, the first response message information may include a specific user interface related to the second area 530. For example, the specific user interface included in the first response message information may be an interface for configuring whether to transmit a second message in case that the electronic device 470 enters into the second area 530.

At least a part of the information included in the first response message (hereinafter, “first response message information”) may be displayed on a notification interface (e.g., notification bar or pop-up) of the electronic device 470. As another example, the first response message information may be displayed on the electronic device 470 as a separate message. According to an embodiment, the electronic device 470 may display the first response message information for a predetermined time interval. If the predetermined time interval elapses, the electronic device 470 may automatically delete the first response message information and remove it from the display. The electronic device 470 may identify an effective time interval of the first response message information, and if the effective time interval elapses, the electronic device 470 may delete the first response message information. If the user enters an input indicating that he has viewed the first response message information, the electronic device 470 may delete the first response message information. According to an embodiment, if the user gets out of the first area 520, the electronic device 470 may delete the first response message information. As another example, if it is identified that the electronic device 470 exits out of the first area 520, the server 410 may transmit a separate message (e.g., third message) for requesting deletion of the first response message information.

According to an embodiment of the disclosure, the electronic device 470 may receive a request for additional information in relation to the first response message (750). If the first response message information is displayed on the electronic device 470, the additional information for the first response message information may be requested. Further, the electronic device 470 may delete the first response message information. If the user deletes the first response message information, the electronic device 470 may be unable to receive the additional information related to the first response message information. For example, if the message including the deleted first response message information is received, the electronic device 470 may not display the message. As another example, the electronic device 470 may not re-receive the first response message by notifying the server 410 of the deletion of the first response message information. If it is determined that the re-reception of the first response message is difficult, the electronic device 470 may configure to prevent the user from deleting the first response message information. For example, the electronic device 470 may prevent the user's deletion by identifying a deletion authority of the first response message information. As still another example, if the first response message is transmitted on a first-come, first-served basis, in order to prevent the deletion of the first response message because of the user's mistake, the electronic device 470 may prevent the user from directly deleting the first response message, or may delete the first response message only after user confirms the deletion. Even if the deletion of the first response message information by the user is prevented, the electronic device may delete the first response message information in accordance with the time or area identification through the system.

According to an embodiment of the disclosure, the electronic device 470 may further identify the location information of the electronic device 470 (760). The electronic device 470 may identify the location information of the electronic device 470 using the processor (e.g., processor 120 of FIG. 1 or application processor 360 of FIG. 3). The electronic device 470 may identify the location information of the electronic device 470 using at least one of the sensor module 176 and/or the communication module 190.

According to an embodiment of the disclosure, the electronic device 470 may identify whether the identified location of the electronic device 470 is changed based on the second area (e.g., second area 530 of FIG. 5) (770). The second area 530 may be an area having a small radius centering around the point of interest (POI).

According to an embodiment of the disclosure, the electronic device 470 may identify the location of the electronic device 470 based on a radio signal being measured in the second area. For example, the electronic device 470 may identify whether the location of the electronic device 470 is changed by measuring signals of a cellular base station located in the second area, Wi-Fi, and Bluetooth. As another example, the electronic device 470 may identify whether the location of the electronic device 470 is changed using an image sensor (e.g., camera) with respect to symbols (e.g., barcode, QR code, and specific image) located in the second area.

According to an embodiment of the disclosure, if the location of the electronic device 470 is changed based on the second area 530 (770—Yes), the electronic device 470 may transmit a second message related to the geofencing service (780). The electronic device 470 may transmit the second message only in case that the user identifies the first response message (e.g., in case that the user presses an identification button or touches the first response message information).

According to an embodiment of the disclosure, if a second response message to the second message is received, the electronic device 470 may display at least a part of information included in the second response message (hereinafter, “second response message information”) (790). The electronic device 470 may display the second response message information on a notification interface. The electronic device 470 may display the second response message information for a predetermined time interval. The display type of the second response message information may be different from the display type of the first response message information. For example, the first response message information may be displayed in the notification bar of the notification interface, and the second response message information may be displayed as a notification message of the notification interface.

According to an embodiment of the disclosure, the electronic device 470 may delete the second response message information only in case that a specific condition is satisfied. For example, if a predetermined time interval elapses, the electronic device 470 may automatically delete the second response message information. The electronic device 470 may identify an effective time interval of the second response message information, and if the effective time interval elapses, the electronic device 470 may delete the second response message information. If the user identifies the second response message information (e.g., if the user presses a button (e.g., “identify” or “delete”), or touches the second response message information), the electronic device 470 may delete the second response message information. Or when the device exits out of the second area 530, the electronic device 470 may delete the second response message information.

According to an embodiment of the disclosure, if the user identifies the second response message information (e.g., if the user presses the “identify” button, or touches the second response message information), a coupon related to discount or gift providing may be displayed. The user may store the coupon included in the second response message in the electronic device 470. According to an embodiment, if the user gets out of the second area 530, the coupon may be withdrawn (e.g., the coupon may be deleted from the screen, or may be displayed in an invalidated or deactivated form on the screen). The server 410 may withdraw the unused coupon, and may issue the same to the electronic device after it re-enters into the second area 530.

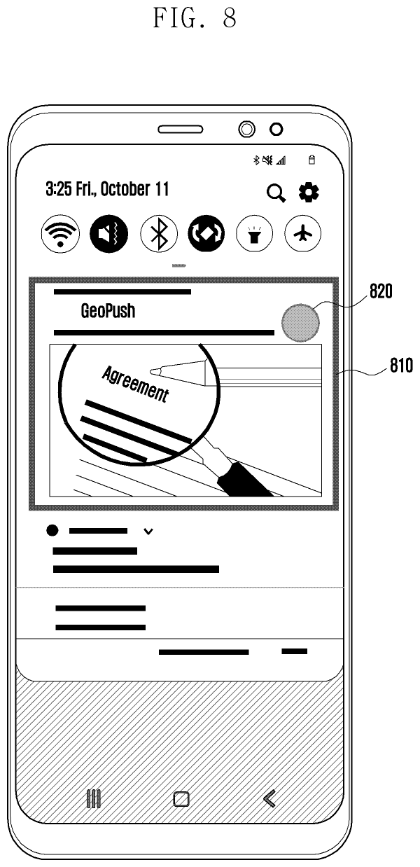

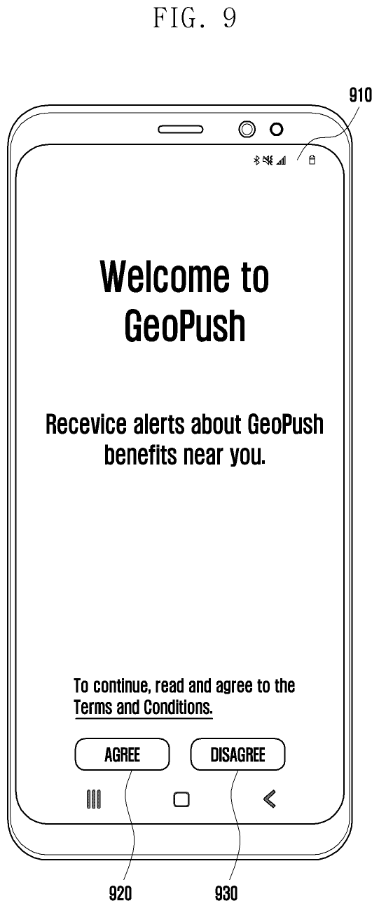

FIGS. 8 and 9 are diagrams illustrating an example in which a user configures an opt in/out according to an embodiment of the disclosure.

According to an embodiment of the disclosure, a user may configure an opt in/out. FIG. 8 may show a user interface through which an electronic device (e.g., electronic device 470 of FIG. 4) notifies a user that an opt in/out configuration 810 is possible. The electronic device 470 may notify the user of the opt in/out configuration 810 through a notification interface (e.g., notification bar). If the user clicks a predetermined area 820 within the opt in/out configuration 810 of the notification interface, a screen 910 for configuring the opt in/out may be shown as illustrated in FIG. 9.

In FIG. 9, if the user clicks an “AGREE” button 920, the user can receive marketing content. If the user clicks a “DISAGREE” button 930, the electronic device 470 may not additionally request the marketing content.

According to an embodiment of the disclosure, the user may configure or change the opt in/out configuration. The opt in/out settings may be provided by system settings of the operating system. The opt in/out settings may be settings provided by the manufacturer of the electronic device 470. Further, the opt in/out settings may be settings provided when an application is installed.

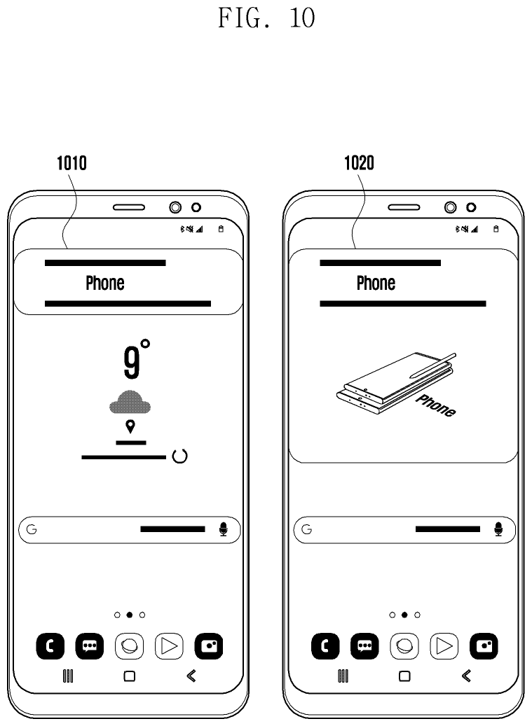

FIG. 10 is a diagram illustrating an example of first response message information displayed on an electronic device according to an embodiment of the disclosure.

According to an embodiment of the disclosure, first response message information 1010 and 1020 may be at least a part of information included in a message being received by an electronic device (e.g., electronic device 470 of FIG. 4) when the identified location of the electronic device 470 is changed based on a first area (e.g., first area 520 of FIG. 5) in the point of interest. The first response message information 1010 and 1020 may be at least a part of information included in the message received by the electronic device 470 having transmitted identification information of the point of interest to a first server (e.g., first server 410 of FIG. 4). The identification information of the point of interest being transmitted by the electronic device 470 may be information based on the identified location information of the electronic device 470. The first response message information 1010 and 1020 may be at least a part of information included in a message being transmitted only in case that the electronic device 470 enters into the first area 520. The first response message information 1010 and 1020 may not be transmitted in case that the electronic device 470 exits out of the first area 520.

According to an embodiment of the disclosure, the first response message information 1010 and 1020 may be displayed on the notification interface. The first response message information 1010 and 1020 may include marketing content. The user may identify detailed information 1020 by swiping down or clicking the first response message information 1010 displayed on the notification interface. If the user is interested in the marketing content included in the first response message information 1010, the user may receive additional information. The user may identify reception of the additional information by tabbing, swiping, or button-pressing the first response message information 1010 and 1020 displayed on the notification interface.

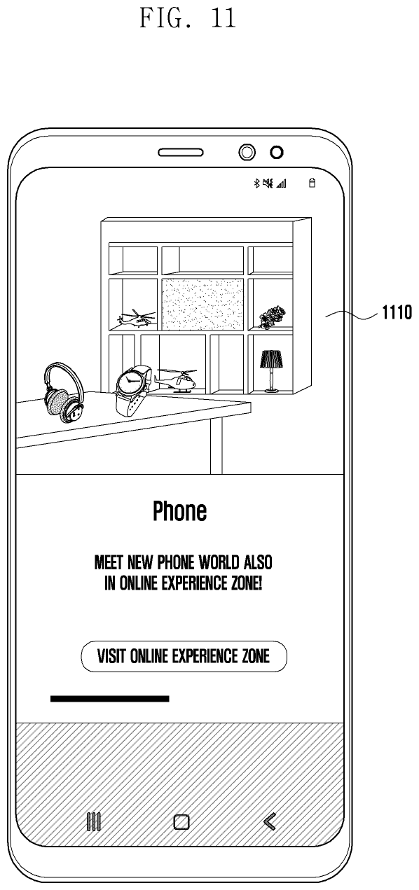

FIG. 11 is a diagram illustrating an example of a screen for identifying additional information on first response message information according to an embodiment of the disclosure.

According to an embodiment of the disclosure, the user may identify additional information by performing a specific operation (e.g., tap, swipe, or button click) on first response message information displayed on a notification interface. FIG. 11 illustrates an example of a screen being displayed on an electronic device (e.g., electronic device 470 of FIG. 4) in case that the user performs a specific operation on the first response message information. For example, in case that marketing content related to a Samsung cellular phone is received as the first response message information, and the user is interested in this, the user may tap the first response message information. The electronic device 470 may display the additional information related to the first response message information on a separate screen 1110.

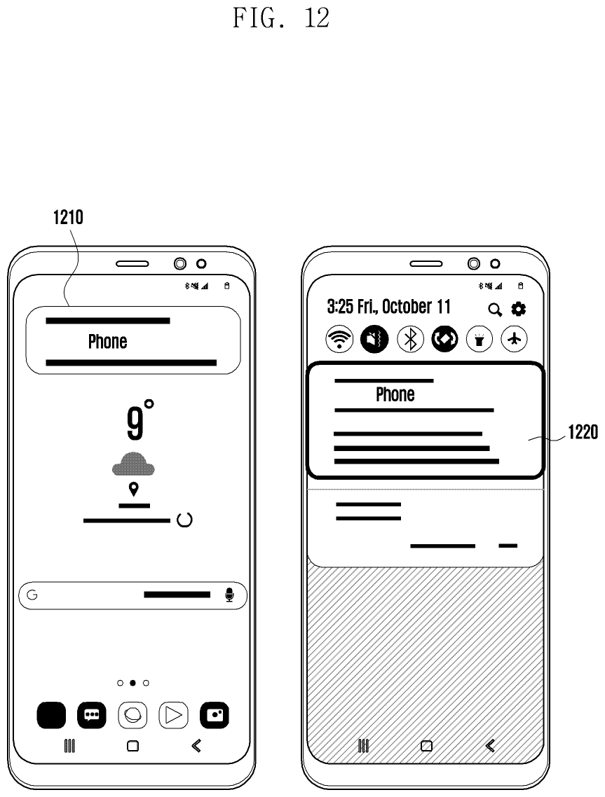

FIG. 12 is a diagram illustrating an example of identifying detailed information of second response message information displayed on an electronic device according to an embodiment of the disclosure.

According to an embodiment of the disclosure, second response message information 1210 and 1220 may be a message being received by an electronic device (e.g., electronic device 470 of FIG. 4) in case that the identified location of the electronic device 470 is changed based on a second area (e.g., second area 530 of FIG. 5) in the point of interest (e.g., entering into the second area). In the same manner as the first response message information (e.g., first response message 1010 of FIG. 10), the second response message information 1210 and 1220 may also be displayed on a notification interface. A user may identify detailed information 1220 by swiping down or clicking the second response message information 1210 displayed on the notification interface.

According to an embodiment of the disclosure, if the identified location of the electronic device 470 is changed based on the second area 530, the electronic device 470 may transmit a second message related to a geofencing service to a first server (e.g., first server 410 of FIG. 4). The electronic device 470 may transmit identification information of the point of interest and location information of the electronic device 470 or information on entry into or exit out of the second area to the first server 410 as the second message. The second response message may be a response message to the second message. The second response message information 1210 and 1220 may be transmitted only in case that the electronic device 470 enters into the second area 530. The second response message information 1210 and 1220 may be transmitted only in case that the electronic device 470 has entered into the second area 530 for over a predetermined time interval. The second response message information 1210 and 1220 may not be transmitted in case that the electronic device 470 exits out of the second area 530. The second response message information 1210 and 1220 may be displayed to the user for a predetermined time interval. If there is not information on an effective time interval in the second response message information 1210 and 1220, how long the second response message information 1210 is displayed may depend on whether the electronic device 470 enters into or exits out of the second area 530. For example, if the electronic device 470 exits out of the second area 530, the second response message information 1210 and 1220 may be deleted or deactivated.

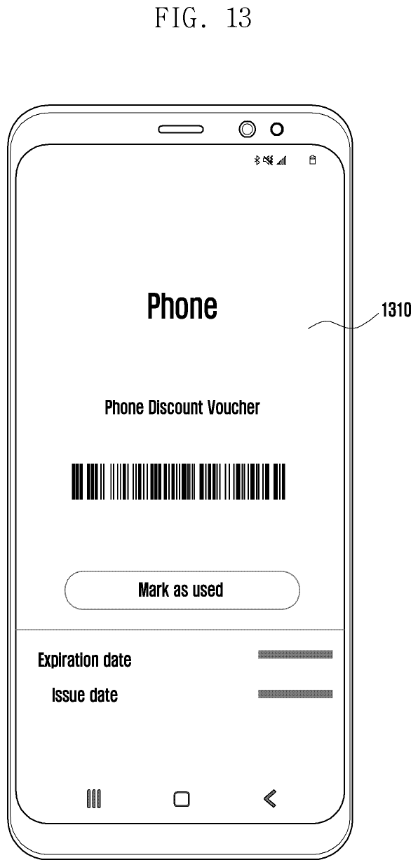

FIG. 13 is a diagram illustrating an example of a screen for identifying additional information on second response message information according to an embodiment of the disclosure.

According to an embodiment of the disclosure, a user who is interested in second response message information (e.g., second response message information 1210 of FIG. 12) may identify additional information by performing a specific operation (e.g., button click, swipe, or tap) on a second response message.

According to an embodiment of the disclosure, additional information of the second response message information 1210 may be displayed on a separate screen 1310. The additional information of the second response message information 1210 may include a discount coupon and a gift coupon.

According to an embodiment of the disclosure, if the user satisfies a specific condition, the coupon included in the additional information of the second response message information 1210 may be returned or removed from the display. The specific condition may be at least one of when the user exits out of the second area 530 for over a predetermined time interval, when the user exits out of the second area 530 over a specified number of times, and when the user gets out of the second area 530 over a predetermined distance. The coupon may also expire after an effective time period. If the discount coupon or the gift coupon is included in the additional information of the second response message information 1210, the effective time (not illustrated) may also be displayed together.

According to an embodiment of the disclosure, if the specific condition is satisfied, the returned or removed coupon may not be re-issued. Such a specific condition may be a psychological factor that compels the user to use the coupon. The returned coupon may be transmitted to another user. A marketing content provider may adjust the number of coupon issues by identifying the returned coupon.

According to an embodiment, the coupon included in the additional information of the second response message information 1210 may be stored in the electronic device 470. In addition to the coupon, the electronic device 470 may further store at least one of information on an area in which the coupon can be used and the marketing content. If the electronic device 470 is located around the area in which the coupon can be used, the electronic device 470 may notify the user of this in the form of the second response message information 1210.

An electronic device according to an embodiment of the disclosure may include: a display, a communication module, a sensor module, and a first processor, wherein the first processor may be configured to: identify first location information of the electronic device, identify whether the identified first location information of the electronic device is within a first area, transmit a first message for requesting information related to a geofencing service in case that the identified first location information of the electronic device is within the first area, receive a first response message to the first message, display at least a part of information included in the first response message on the display, re-identify second location information of the electronic device, identify whether the re-identified second location information of the electronic device is out of a second area, and delete the information displayed on the display in case that the re-identified second location information of the electronic device is out of the second area.

In the electronic device according to an embodiment of the disclosure, the part of the information included in the first response message displayed on the display may be configured as information that is unable to be deleted by a user from the display.

In the electronic device according to an embodiment of the disclosure, the second area may be larger than or equal to the first area.

The electronic device according to an embodiment of the disclosure may further include a second processor, wherein the second processor may be configured to identify third location information of the electronic device based on strength of at least one base station signal, and to transfer third location information identified by the second processor to the first processor, and the first processor may be configured to identify first location information of the electronic device based on strength of at least one Wi-Fi access point (AP) signal.

In the electronic device according to an embodiment of the disclosure, the second processor may be configured to determine a timing for the first processor to identify third location information by identifying movement pattern information of the electronic device acquired from the sensor module, and to request the first processor to identify first location information of the electronic device in the determined timing.

In the electronic device according to an embodiment of the disclosure, the first message may further include identification information of a point of interest (POI) based on the identified first location information of the electronic device and information indicating that the electronic device enters into the first area.

In the electronic device according to an embodiment of the disclosure, the first processor may request a list of points of interest based on the identified first location information of the electronic device.

In the electronic device according to an embodiment of the disclosure, the first processor may be configured to delete the information displayed on the display by further identifying whether a predetermined time interval satisfies a first predetermined condition and/or a number of times the electronic device enters into the second area satisfies a second predetermined condition.

In the electronic device according to an embodiment of the disclosure, the first response message may be deleted only by a user's specific input.

In the electronic device according to an embodiment of the disclosure, the first response message may include a coupon related to providing of a discount or a gift.

A method for operating an electronic device providing a geofencing service according to an embodiment of the disclosure may include: identifying, by a first processor, first location information of the electronic device; identifying, by the first processor, whether the identified first location information of the electronic device is within a first area; transmitting, by the first processor, a first message for requesting information related to a geofencing service in case that the identified first location information of the electronic device is within the first area; receiving, by the first processor, a first response message to the first message; displaying, by the first processor, at least a part of information included in the first response message on a display; re-identifying, by the first processor, second location information of the electronic device; identifying, by the first processor, whether the re-identified second location information of the electronic device is out of a second area; and deleting, by the first processor, the information displayed on the display in case that the re-identified second location information of the electronic device is out of the second area.

In the method for operating the electronic device providing the geofencing service according to an embodiment of the disclosure, the part of the information included in the first response message displayed on the display may be configured as information that is unable to be deleted by a user from the display.

In the method for operating the electronic device providing the geofencing service according to an embodiment of the disclosure, the second area may be larger than or equal to the first area.

The method for operating the electronic device providing the geofencing service according to an embodiment of the disclosure may further include: identifying, by a second processor, third location information of the electronic device based on strength of at least one base station signal, and transferring third location information identified by the second processor to the first processor; and identifying, by the second processor, first location information of the electronic device based on strength of at least one Wi-Fi access point (AP) signal.

The method for operating the electronic device providing the geofencing service according to an embodiment of the disclosure may further include determining, by the second processor, a timing for the first processor to identify third location information by identifying movement pattern information of the electronic device acquired from a sensor module, and requesting the first processor to identify first location information of the electronic device in the determined timing.

In the method for operating the electronic device providing the geofencing service according to an embodiment of the disclosure, the first message may further include identification information of a point of interest (POI) based on the identified first location information of the electronic device and information indicating that the electronic device enters into the first area.

The method for operating the electronic device providing the geofencing service according to an embodiment of the disclosure may further include requesting, by the first processor, a list of points of interest based on the identified first location information of the electronic device.

The method for operating the electronic device providing the geofencing service according to an embodiment of the disclosure may further include deleting, by the first processor, the information displayed on the display by further identifying whether a predetermined time interval satisfies a first predetermined condition and/or a number of times the electronic device enters into the second area satisfies a second predetermined condition.

In the method for operating the electronic device providing the geofencing service according to an embodiment of the disclosure, the first response message may be deleted only by a user's specific input.

In the method for operating the electronic device providing the geofencing service according to an embodiment of the disclosure, the first response message may include a coupon related to providing of a discount or a gift.

Other embodiments are also possible.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

Certain of the above-described embodiments of the present disclosure can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein.

While the present disclosure has been shown and described with reference to various embodiments thereof, it will be understood by those skilled in the art that various changes in form and details may be made therein without departing from the present disclosure as defined by the appended claims and their equivalents.

What is claimed is:

1. An electronic device comprising:
a display;
a communication module;
a sensor module; and
a first processor,
wherein the first processor is configured to:
identify first location information of the electronic device,
identify whether the identified first location information of the electronic device is within a first area,
transmit a first message for requesting information related to a geofencing service in case that the identified first location information of the electronic device is within the first area,
receive a first response message to the first message,
display at least a part of information included in the first response message on the display,
re-identify second location information of the electronic device,
identify whether the re-identified second location information of the electronic device is out of a second area, and
delete the information displayed on the display in case that the re-identified second location information of the electronic device is out of the second area.

2. The electronic device of claim 1, wherein the part of the information included in the first response message displayed on the display is configured as information that is unable to be deleted by a user from the display.

3. The electronic device of claim 1, wherein the second area is larger than or equal to the first area.

4. The electronic device of claim 1, further comprising a second processor,
wherein the second processor is configured to identify third location information of the electronic device based on strength of at least one base station signal, and to transfer third location information identified by the second processor to the first processor, and
the first processor is configured to identify first location information of the electronic device based on strength of at least one Wi-Fi access point (AP) signal.

5. The electronic device of claim 4, wherein the second processor is configured to determine a timing for the first processor to identify third location information by identifying movement pattern information of the electronic device acquired from the sensor module, and to request the first processor to identify first location information of the electronic device in the determined timing.

6. The electronic device of claim 5, wherein the first message further comprises identification information of a point of interest (POI) based on the identified first location information of the electronic device and information on that the electronic device enters into the first area.

7. The electronic device of claim 1, wherein the first processor is configured to request a list of points of interest based on the identified first location information of the electronic device.

8. The electronic device of claim 1, wherein the first processor is configured to delete the information displayed on the display by further identifying whether a predetermined time interval satisfies a first predetermined condition and/or whether a number of times the electronic device enters into the second area satisfies a second predetermined condition.

9. The electronic device of claim 1, wherein the first response message is deleted only by a user's specific input.

10. The electronic device of claim 1, wherein the first response message further comprises a coupon related to providing of a discount or a gift.

11. A method for operating an electronic device providing a geofencing service, the method comprising:
identifying, by a first processor, first location information of the electronic device;
identifying, by the first processor, whether the identified first location information of the electronic device is within a first area;
transmitting, by the first processor, a first message for requesting information related to a geofencing service in case that the identified first location information of the electronic device is within the first area;
receiving, by the first processor, a first response message to the first message;
displaying, by the first processor, at least a part of information included in the first response message on a display;
re-identifying, by the first processor, second location information of the electronic device;
identifying, by the first processor, whether the re-identified second location information of the electronic device is out of a second area; and
deleting, by the first processor, the information displayed on the display in case that the re-identified second location information of the electronic device is out of the second area.

12. The method of claim 11, wherein the part of the information included in the first response message displayed on the display is configured as information that is unable to be deleted by a user from the display.

13. The method of claim 11, wherein the second area is larger than or equal to the first area.

14. The method of claim 11, further comprising:
identifying, by a second processor, third location information of the electronic device based on strength of at least one base station signal, and transferring third location information identified by the second processor to the first processor; and
identifying, by the first processor, first location information of the electronic device based on strength of at least one Wi-Fi access point (AP) signal.

15. The method of claim 14, further comprising determining, by the second processor, a timing for the first processor to identify third location information by identifying movement pattern information of the electronic device acquired from a sensor module, and requesting the first processor to identify first location information of the electronic device in the determined timing.

16. The method of claim 15, wherein the first message further comprises identification information of a point of interest (POI) based on the identified first location information of the electronic device and information indicating that the electronic device enters into the first area.

17. The method of claim 11, further comprising requesting, by the first processor, a list of points of interest based on the identified first location information of the electronic device.

18. The method of claim 11, further comprising deleting, by the first processor, the information displayed on the display by further identifying whether a predetermined time interval satisfies a first predetermined condition and/or whether a number of times the electronic device enters into the second area satisfies a second predetermined condition.

19. The method of claim 11, wherein the first response message is deleted only by a user's specific input.

20. The method of claim 11, wherein the first response message further comprises a coupon related to providing of a discount or a gift.
